(19) United States
(12) Patent Application Publication
(10) Pub. No.: US 2022/0307292 A1
(43) Pub. Date: Sep. 29, 2022

(54) SECURITY APPARATUS AND SECURE DISPLAY SYSTEM FOR SPORTS EQUIPMENT

(71) Applicant: Scorpion Security Products, Inc., Vestal, NY (US)

(72) Inventors: Franklyn W. Gulick, JR., Binghamton, NY (US); Gary R. Page, Chenango Forks, NY (US); Patrick McEwen, Greene, NY (US); Patrick Dunleavy, Endwell, NY (US); Andrew Bartoszewski, Syracuse, NY (US); Grant William Gulick, Endwell, NY (US)

(73) Assignee: Scorpion Security Products, Inc., Vestal, NY (US)

(21) Appl. No.: 17/701,386

(22) Filed: Mar. 22, 2022

Related U.S. Application Data
(60) Provisional application No. 63/165,417, filed on Mar. 24, 2021.
(60) Provisional application No. 63/234,475, filed on Aug. 18, 2021.

(51) Int. Cl. E05B 73/00; A47F 7/00; A47B 81/00

(52) U.S. Cl. CPC E05B 73/0017; A47F 7/0028; A47B 81/005

(57) ABSTRACT

A security apparatus for securing a piece of sports equipment includes a housing and an extension having a first end that extends from the housing and a second end this is positioned within the housing. A lock assembly includes a barrel having a first end and a second end. A lock body is positioned within the housing and is operatively coupled to the barrel. When the lock assembly is in the locked state, the first end of the extension member engages a first portion of the piece of sports equipment, the lock body engages the second end of the extension member to inhibit axial movement of the extension member to secure the first portion of the piece of sports equipment against the extension member, and the lock body extends from the housing to engage a second portion of the piece of sports equipment.

### CROSS-REFERENCE TO RELATED APPLICATIONS/PRIORITY CLAIM

This application is related, and claims priority to, commonly owned Provisional Patent Application Ser. No. 63/165,417, filed Mar. 24, 2021 and Provisional Patent Application Serial. No.: 63/234,475, filed Aug. 18, 2021. The entire contents of these applications are hereby incorporated by reference.

### TECHNICAL FIELD

The foregoing disclosure relates to security apparatus enabling secure display of sports equipment at the same time as well as easy removal an re-securing of said sports equipment by retail employees. The foregoing disclosure also relates to a secure display system comprising multiple security apparatuses that securely display a plurality of multiple pieces of sports equipment.

### BACKGROUND OF THE INVENTION

Shoplifting is a cost of doing business for retailers and securing inventory while displaying it for consumers is a real challenge. In many retail settings, expensive inventory or merchandise is housed in locked cabinets, secure back rooms, or is even kept behind the checkout counter. These methods require the assistance of a store employee to release the merchandise to the customer for inspection. While these methods of securing inventory work reasonably well for items that are not frequently purchased by consumers, or by retail settings that service small numbers of clients at a time, they are too restrictive for inventory that is frequently bought by consumers or for high traffic retail settings.

Multi-part golf clubs, such as clubs with removable heads, like irons, woods, and putters, are becoming increasingly popular and increasingly expensive as well. These types of golf clubs enable the golfer to change club heads due to damage, obsolescence, or in a simple attempt to improve their game. In addition, removable club heads also increase the ease at which new club shafts can be installed on the club heads. Currently, drivers with removeable club heads are one of the most popular pieces of golf equipment and consequently, one of the most prone to theft. In the retail setting, golfers are accustomed to handling golf clubs to test their balance, weight, and overall physical and visual appeal. Current security devices enable golf clubs to be tethered to a display fixture or may comprise an alarm triggered by an RFID, magnetic, or other such tag. While these classic methods of securing golf clubs may work well for the standard golf club, detachable head golf clubs pose a new challenge as the detachable heads themselves are becoming targets for theft. Other security devices enable the customer to remove the golf club from the display for inspection. Unfortunately, many customers then test these golf clubs by hitting golf balls while the security device is still in place. As a result, the security devices can become damaged, broken, or otherwise unusable, which leaves the golf clubs unsecured and increases costs for retailers.

These are just some of the disadvantages with current security systems used for securely displaying golf clubs in retail settings.

### BRIEF SUMMARY OF THE INVENTION

An embodiment of a security apparatus for securing a golf club includes a housing defining a pocket and an extension member including a first end and a second end. The first end extends from the housing and the second end is positioned within the housing. A lock assembly is at least partially positioned within the housing and configured to move between a locked state and an unlocked state. The lock assembly includes a barrel configured to move relative to the housing and having a lock interface at a first end and a ram that is operatively coupled to an opposing second end. A lock body is positioned within the housing and adjacent to the ram. A first locking extension operatively is coupled to the lock body and is positioned within the housing. A second locking extension is at least partially positioned within the housing and is operatively coupled to the lock body. When the lock assembly is in locked state, the first end of the extension member engages a first portion of the golf club, the first locking extension engages the second end of the extension member to inhibit axial movement of the extension member to secure the first portion of the golf club against the extension member, and the second locking extension extends from the housing to engage a second portion of the golf club. In this manner, the golf club is secured between the extension member, the second locking extension and the pocket.

In an embodiment, the first end of the extension member further includes an engagement member structured to mate with the first portion of the golf club. In an embodiment, the housing further includes a plurality of sides that define a passage configured to accept a portion of a support. In another embodiment, the barrel further includes one or more protruding surfaces that engage one or more surface features on an inner surface of the housing when the lock assembly is in the locked state to inhibit axial movement of the barrel relative to the housing. In an embodiment, the housing further includes a first housing portion pivotally coupled to a second housing portion, wherein the second housing portion is configured to secure the golf club. When the lock assembly is in the unlocked state, the first locking extension is disengaged from the second end of the extension member to enable axial movement of the extension member, the second locking extension is retracted from the second portion of the golf club. The extension member is then lifted away from the first portion of the golf club and the second portion of the golf club is enabled to be removed from the pocket of the housing.

An embodiment of a security apparatus for securing a piece of sports equipment includes a housing defining a pocket and an extension having a first end configured to extend from the housing and a second end positioned within the housing. A lock assembly defines a locked state and an unlocked state. The lock assembly comprises a barrel configured to move relative to the housing and having a first end and a second end, and a lock body positioned within the housing and operatively coupled to the barrel. When the lock assembly is in the locked state, the first end of the extension member engages a first portion of the piece of sports equipment, the lock body engages the second end of the extension member to inhibit axial movement of the extension member to secure the first portion of the piece of sports equipment against the extension member, and the lock body extends from the housing to engage a second portion of the piece of sports equipment. In this manner, the piece of sports equipment is secured between the extension member, the lock body and the pocket.

An embodiment of a secure display system includes a support configured to couple to a display fixture and a plurality of security apparatuses configured to couple to the support. Each of the security apparatuses is structured to secure a piece of sports equipment and each includes a housing defining a pocket, an extension including a first end configured to extend from the housing and a second end positioned within the housing and a lock assembly configured to move between a locked state and an unlocked state. The lock assembly includes a barrel that moves relative to the housing and has a first end and a second end, and a lock body positioned within the housing and operatively coupled to the barrel. When the lock assembly is in the locked state, the first end of the extension member engages a first portion of the piece of sports equipment, the lock body engages the second end of the extension member to inhibit axial movement of the extension member to secure the first portion of the piece of sports equipment against the extension member, and the lock body extends from the housing to engage a second portion of the piece of sports equipment. In this manner, the piece of sports equipment is secured between the extension member, the lock body and the pocket.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIG. 1A illustrates an side view of an embodiment of an apparatus for securing multiple golf clubs in a retail display in which one or more sides of a housing are shown as transparent in order to see the components assembled therein;

FIG. 1B illustrates a side view of an embodiment an apparatus for securing multiple golf clubs in a retail display in which one or more sides of a housing are shown as transparent in order to see the components assembled therein;

FIG. 2 illustrates a top view of an embodiment an apparatus for securing multiple golf clubs in a retail display in which one or more sides of a housing are shown as transparent in order to see the components assembled therein;

FIG. 3 illustrates a perspective view of an embodiment of the apparatus for securing multiple golf clubs in a retail display and an example of a golf club;

FIG. 4 illustrates a perspective view of an embodiment of the apparatus for securing multiple golf clubs in a retail display with an embodiment of a golf club being installed;

FIG. 5 illustrates a close-up perspective view of the embodiment of FIG. 4 in an unlocked position;

FIG. 6 illustrates a perspective view of an embodiment of the apparatus for securing multiple golf clubs in a retail display shown in an open position and with an embodiment of a golf club being installed;

FIG. 7 illustrates a perspective view of an embodiment of the apparatus for securing multiple golf clubs in a retail display shown in a closed or locked position with an embodiment of a golf club being secured;

FIG. 8 illustrates a close-up perspective view of an embodiment of a locking assembly of the apparatus for securing multiple golf clubs in a retail display in an unlocked position;

FIG. 9 illustrates a close-up perspective view of an embodiment of a locking assembly of the apparatus for securing multiple golf clubs in a retail display in a locked position;

FIG. 10 illustrates a side view of embodiments of two golf clubs secured in an embodiment of a secure display system for multiple golf clubs in which one or more sides of a housing are shown as transparent in order to see the components assembled therein;

FIG. 11 illustrates a perspective view of multiple golf clubs secured in an embodiment of the secure display system for multiple golf clubs in which one or more sides of a housing are shown as transparent in order to see the components assembled therein;

FIG. 12 illustrates another perspective view of multiple golf clubs secured in an embodiment of the secure display system for multiple golf clubs;

FIG. 13 illustrates a front perspective view of another embodiment of an apparatus for securing a golf club;

FIG. 14 illustrates a side perspective view of the apparatus for securing a golf club;

FIG. 15 illustrates partially exploded view of the apparatus for securing a golf club;

FIG. 16 illustrates a front perspective view of the apparatus for securing a golf club in which one or more sides of a housing are shown as transparent in order to see the components assembled therein:

FIG. 17 illustrates another front perspective view of the apparatus for securing a golf club in which one or more sides of a housing are shown as transparent in order to see the components assembled therein;

FIG. 18 illustrates a top view of the apparatus for securing a golf club in which one or more sides of a housing are shown as transparent in order to see the components assembled therein;

FIG. 19 illustrates an exploded view of the apparatus for securing a golf club;

FIG. 20 illustrates a side perspective view of a secure display system for multiple golf clubs comprising a plurality of the apparatuses for securing a golf club with golf clubs installed and couple to a display fixture;

FIG. 21 illustrates a front perspective view of a secure display system comprising a plurality of the apparatuses for securing a golf club;

FIG. 22 illustrates a front perspective view of another embodiment of an apparatus for securing a golf club;

FIG. 23 illustrates a top view of the embodiment of the apparatus for securing a golf club from FIG. 22;

FIG. 24 illustrates a rear view of the embodiment of the apparatus for securing a golf club from FIG. 22;

FIG. 25 illustrates a front perspective view of two apparatuses for securing a golfclub;

FIG. 26 illustrates a front perspective view of another embodiment of a secure display system for golf clubs comprising a plurality of apparatuses for securing a golf club from FIG. 25;

FIG. 27A illustrates a front view of an embodiment of a an apparatus for securing golf clubs with a safety device secured thereto;

FIG. 27B illustrates a side view of the embodiment of FIG. 27A; and

FIG. 28 illustrates a top view of the embodiment of FIG. 27A.

The attached drawings are for purposes of illustration and are not necessarily to scale.

### DETAILED DESCRIPTION OF THE INVENTION

Golf club technology is constantly changing and new designs, including golf clubs with removable or interchangeable heads, are becoming increasingly popular with consumers. As the cost of clubs increases, they are increasingly becoming targets for theft in stores or sales settings by removing the heads in the store. As described in the following disclosure, the inventive security apparatus for golf clubs and associated system incorporates security measures to secure the golf club head as well as the shatd of the golf club and may be installed on current retail fixtures. The disclosed security apparatus for golf clubs is configured to provide better theft protection of golf clubs in a sales setting that those devices currently being used.

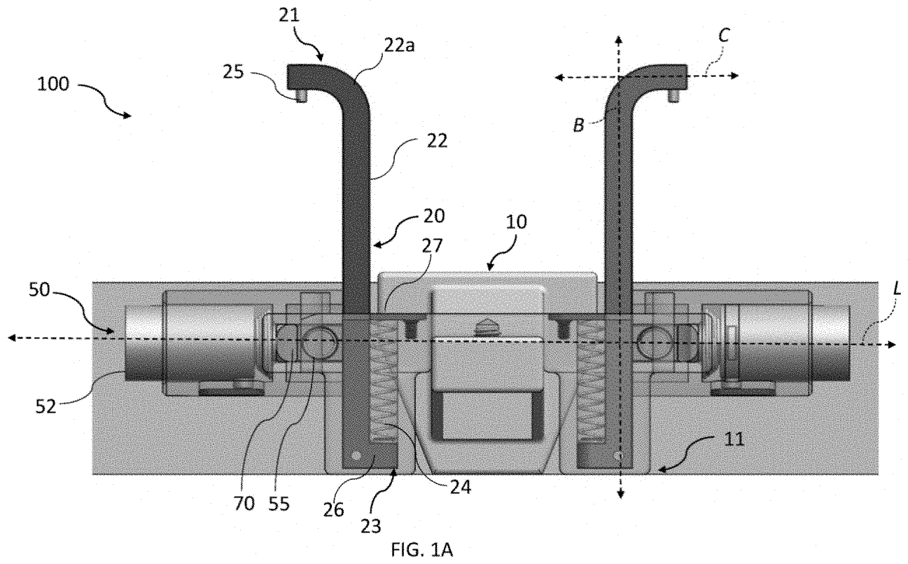

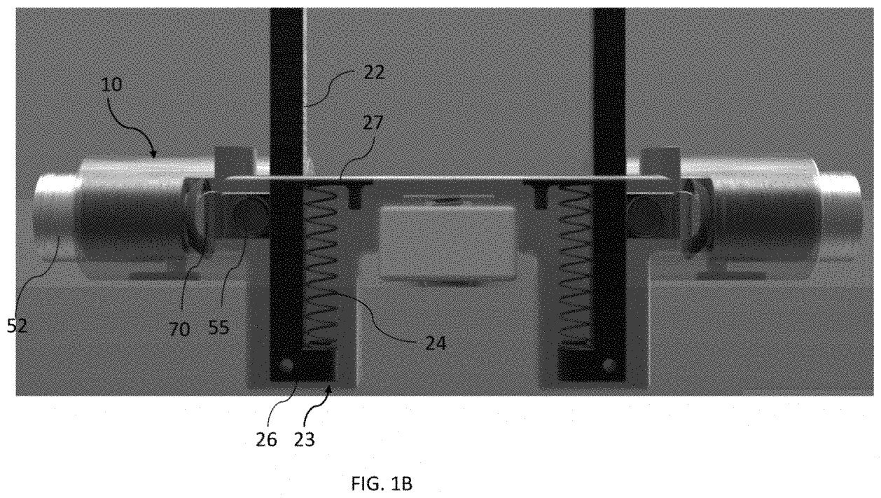

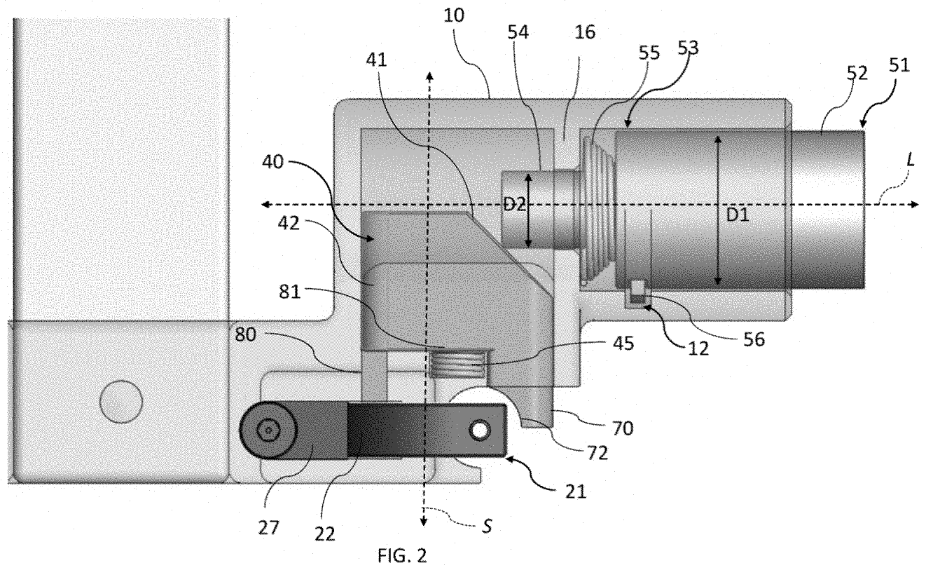

FIGS. 1A-2 illustrate an embodiment of the security apparatus for golf clubs (“security apparatus”) 100. The security apparatus 100 generally comprises a club head securing portion 20, a club shall securing portion 40, and a locking assembly 50. The components of the security apparatus 100 are at least partially surrounded by a housing 10. FIGS. 1A-2, 10, and 11 show images of the security apparatus 100 where some components located in and normally obscured by the housing 10 may be seen (X-ray view). The security apparatus 100 may be configured to secure a single golf club, or may be coupled to other security apparatuses to secure more than one golf club in a system. The following description pertains to the components involved in securing a single golf club recognizing that the inventive security apparatus 100 can be configured to secure more than one golf club in a similar manner.

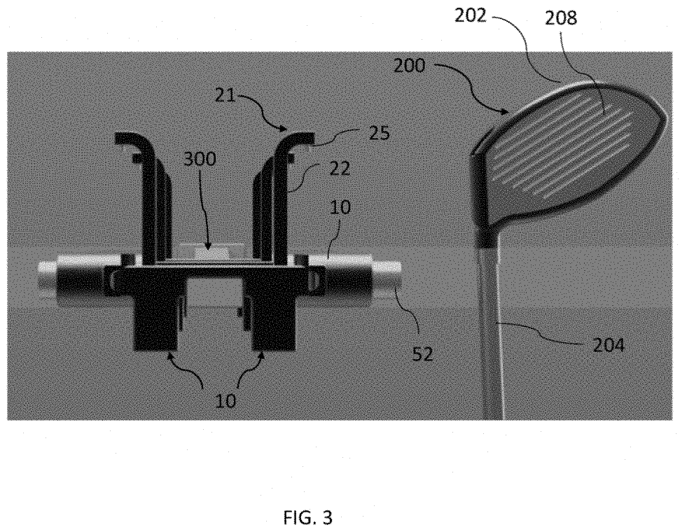

The security apparatus 100 includes a club head securing portion 20 which has an extension or extension member 22 that extends along an axis B from a first end 21 positioned outside and away from the housing 10 and an second end 23 positioned within the housing 10. The extension member 22 defines a plurality of surface features, such as ridges or teeth, on at least a portion of one side. The first end 21 of the extension member 22 includes a transition portion 22a of the extension member 22 that transitions to extend along an axis C that intersects the axis B. An engagement member 25 may also be positioned at the first end 21 and is structured to engage a portion of a golf club 200 (FIG. 3). In an embodiment, the engagement member 25 and the extension member 22 are formed as a single integrated component. In other embodiments, the engagement member 25 is a separate component that is attached to the first end 21 of the extension member 22 and may be replaced with a different engagement member 25 depending on the size and shape of the golf club 200 being secured. In an embodiment, the engagement member 25 protrudes from the extension member 22.

The second end 23 of the extension member 22 is configured to contact or otherwise accept a portion of a biasing member 24. One end or a portion of the biasing member 24 contacts or is seated on a shoulder or an extension leg 26 of the extension member 22 such that the second end 23 of the extension member 22 has an “L-shape” configuration. As shown in FIGS. 1A and 1B, the biasing member 24 is a resilient member such as a spring, or specifically a coil spring. A plate 27 or covering is coupled to the housing 10 and positioned proximate the extension member 22 and above the extension leg 26. As shown, the biasing member 24 is retained between the extension leg 26 and the plate 27 in order to bias the second end 23 towards the bottom 11 of the housing 10.

Turning to FIGS. 1B and 2, the locking assembly 50 of the golf club security apparatus 100 generally comprises a barrel 52 and a shaft securing portion 40. The barrel 52 has a first end 51 and an opposing second end 53. In an embodiment, the first end 51 of the barrel 52 defines an opening or interface 58 configured to accept a key member (not shown), however other embodiments of the locking assembly 50 may instead have a biometric interface or other electronic interface or receiver (Bluetooth @, RFID, or the like). The second end 53 of the barrel 52 couples to or contacts a barrel ram 54 or body contact member. As shown, the barrel 52 comprises a first diameter D1 and the barrel ram 54 comprises a second diameter D2 that is smaller than the first diameter D1. In an embodiment, the barrel 52 and the barrel ram 54 may be formed as a single unitary component, however in other embodiments they may be separate components that are joined together or positioned proximate each other. A barrel member biaser 55 is positioned around the barrel ram 54 and abutting the second end 53 of the barrel 52. The barrel 52, the barrel ram 54, and the barrel member biaser 55 are configured to be at least partially inserted into the housing 10. As shown in FIG. 2, the housing 10 includes an interior wall 16 or divider defining a passage large enough for the barrel ram 54 to be inserted through, but not large enough for the barrel member biaser 55 or the barrel 52 to pass through. The barrel 52 may further include one or more protruding surfaces 56 that are configured to be at least partially accepted by one or more indents, depressions, grooves 12 or other such surface features on the inner surface of the housing 10 when the locking assembly is in the locked state. When the one or more protruding surfaces 56 are engages with the one or more corresponding surface features 12, axial movement of the barrel 52 relative to the housing 10 is inhibited.

Still referring to FIG. 2, the club shaft securing portion 40 is generally positioned proximate to the barrel ram 54 and comprises a body 42 at least partially enclosed within the housing 10. The body 42 contacts one end of a body member biaser 45 and the other end of the body member biaser 45 contacts an inner surface of the housing 10. A first locking extension 70 and a second locking extension 80 extend from the body 42. In an embodiment, the first and second locking extensions 70, 80 are formed as a single unit with the body 42. The body 42 further defines a graduated or angled surface 41 generally positioned at an opposing end of the body 42 from the first and second locking extensions 70, 80.

The barrel member biaser 55 and the body member biaser 45 act to bias the barrel 52 and the body 42, respectively into an unlocked state. In order to move the security apparatus 100 to the locked position, the barrel 52 is depressed into the housing 10 along the barrel axis L such that the one or more protruding surfaces 56 interact with the one or more indents 12 in the inner surface of the housing 10. Depression of the barrel 52 into the housing 10 advances the barrel ram 54 into the angled surface 41 of the body 42 while compressing the barrel member biaser 55. As the barrel ram 54 rides along the angled surface 41 of the body 42, the body 42 is moved along a body axis S and compresses the body member biaser 45. As show in FIG. 2, the barrel axis L intersects the body axis S. Movement of the body 42 along the body axis S advances the first and second locking extensions 70, 80. The first locking extension 70 advances outside of the housing 10 and the second locking extension 80 advances toward the extension member 22 and engages the one or more surface features of the extension member 22 thereby inhibiting movement of the extension member 22 relative to the housing 10 along the extension member axis B.

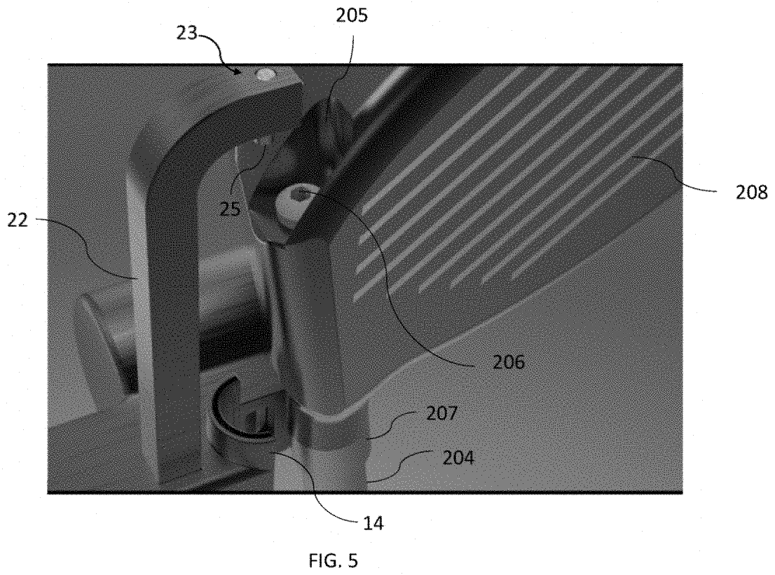

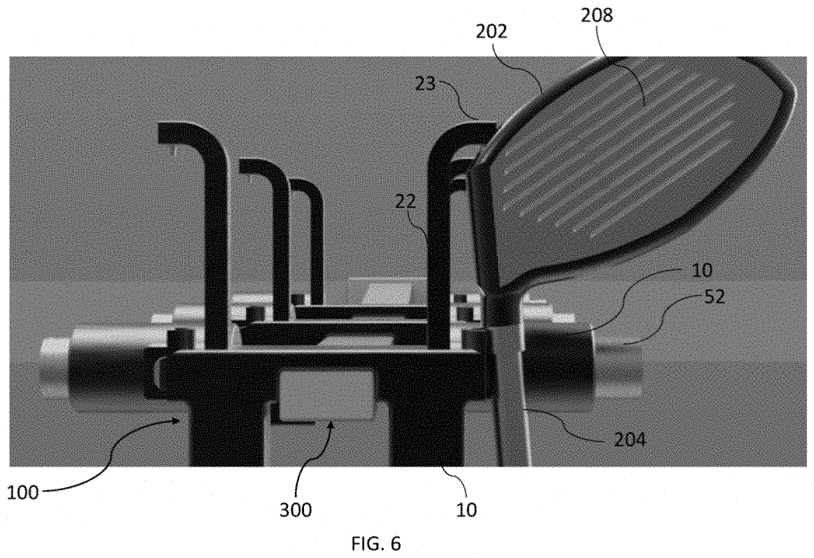

The process of securing and releasing a golf club 200 from the security apparatus 100 will now be described with reference to FIGS. 3-9. FIG. 3 shows the security apparatus 100 in the unlocked state where the barrel 52 is biased such that it protrudes substantially from the housing 10 and the body 42 is biased such that the second locking extension 80 (FIG. 2) does not engage the extension member 22 (FIG. 1A). The security apparatus 100 is positioned or secured onto a display fixture 300 to accept a golf club 200 oriented upside-down so that the club head 202 is above the shaft 204. As shown, the type of golf club 200 being secured by the security apparatus 100 is a right-handed driver, however it is possible that other types of golf clubs, including left-handed clubs, may also be secured using the security apparatus.

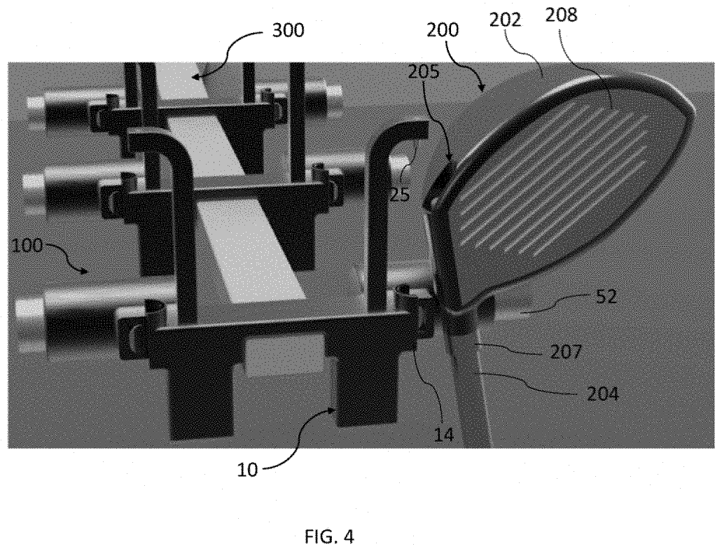

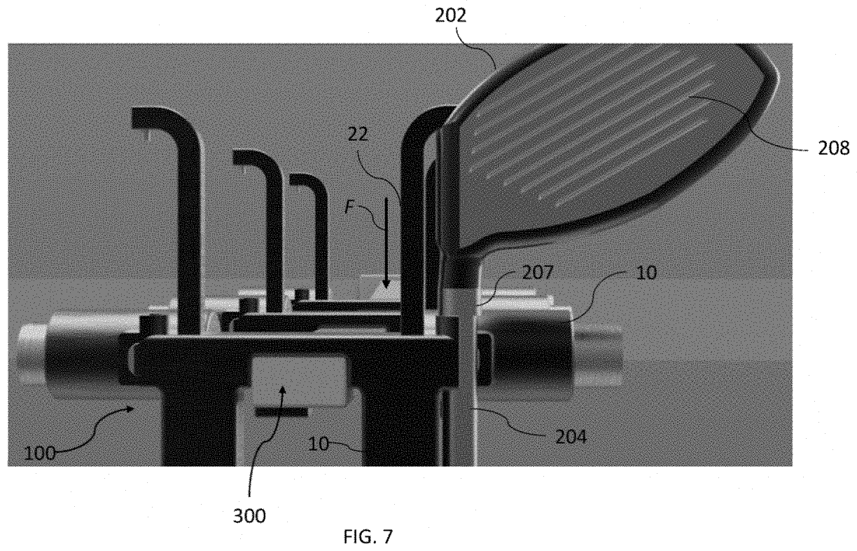

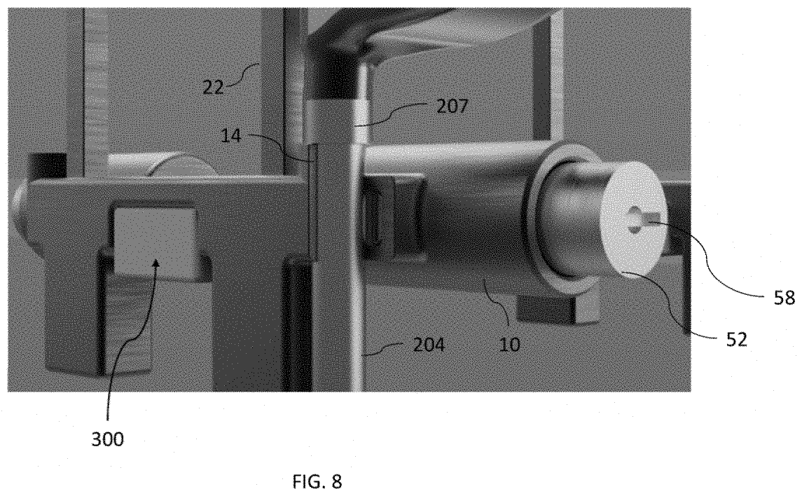

FIGS. 4-6 show the golf club 200 being brought into position with the security apparatus 100. The golf club head 202 is first brought into contact with the extension member 22 such that the engagement member 25 engages the club head fastener 206 positioned in a club head recess 205. When the engagement member 25 engages the club head fastener 206, the extension member is pushed or moved up along the extension member axis B (FIG. 1A). Referring to FIGS. 7 and 8, the shaft 204 is then moved to engage the shaft pocket 14, which is at least partially defined in the housing, such that the club head lip 207 rests on top of the shaft pocket 14. The biasing member 24 acts to exert a force F (FIG. 7) on the golf club 200 in a direction away from the golf club head 202 when the golf club 200 is installed into the security apparatus 100. This force F acts to retain the golf club head 202 between the engagement member 25 and the top of the shaft pocket 14. At this point, the first locking extension 70 is in a retracted position, which enables the shaft 204 to be freely inserted into or removed from the shaft pocket 14.

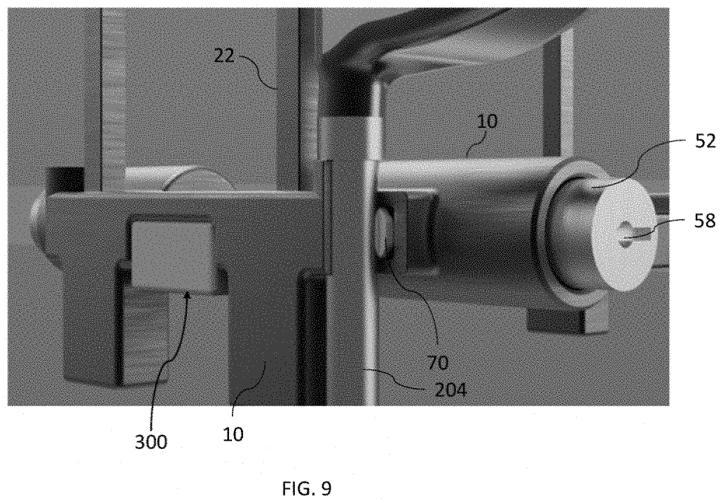

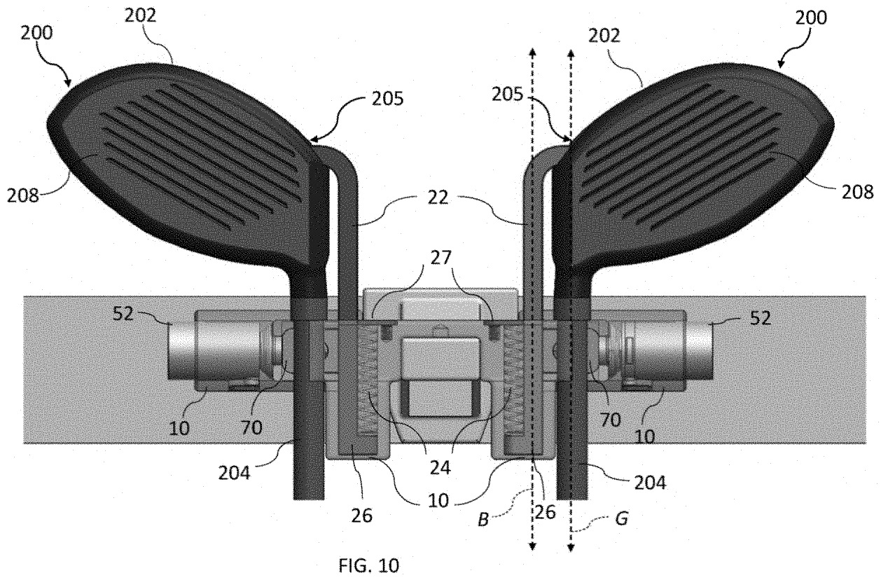

Turning to FIGS. 9 and 10, the barrel 52 is depressed into the housing 10 until the barrel 52 locks in place or cannot be translated relative to the housing 10. As the barrel 52 is depressed, the first locking extension 70 extends from the housing 10 to engage the shaft 204 and/or inhibit the shaft 204 from being freely removed from the shaft pocket 14. Referring back to FIG. 2, the first locking extension 70 may comprise a shaft engagement surface 72 that is beveled, rounded, or otherwise contoured to the shape of the shaft 204 of the golf club 200. At the same time that the first locking extension 70 moves, the second locking extension 80 moves into engagement with the extension member 22 and engages with at least one of the surface features of the extension member 22 to inhibit movement of the extension member 22. The extension member 22 is now inhibited from being lifted away from the club head 202 and the shaft 204 is inhibited from being removed from the shaft pocket 14. The golf club 200 is now secured within the security apparatus 100.

In order to remove the golf club 200, the locking assembly 50 is unlocked at the lock interface 58 using a key or other device to move the locking assembly 50 from the locked to the unlocked state. When the barrel 52 is moved to the unlocked position, the one or more protruding surfaces 56 disengage the one or more indents, depressions, grooves 12 or other such surface features on the inner surface of the housing 10. As a result, the barrel biasing member 55 urges the first end of the barrel 52 away from the housing 10. The barrel ram 54 is retracted from the body 42 such that the body biasing member 45 urged the body along the body axis towards the barrel ram 54 and the first and second locking extensions 70, 80 are retracted along with the body 42. The golf club shaft may not be removed from the pocket 14 and the extension member 22 can be lifted to disengage the engagement member 25 and remove the club head 202.

The key may be any kind of key suitable for locking and unlocking a locking assembly such as a magnetic key, a dimple key, mechanically cut key, or other such key. In a further embodiment, one or more components of the security apparatus 100 may be electronically controlled using one or more actuators and being controlled using a FOB, key card, Bluetooth®, RFID tag or a biometric locking system. In an embodiment, the security apparatus 100 includes an alarm that is activated if the extension member 22, the lock interface 58, the barrel 52, the first locking extension 70 and/or the second locking extension 80 is damaged or forcibly moved out of the locked position. The alarm may be powered by a power source located within the housing 10 or may be connected to an external power source. When the alarm is triggered, it may produce an auditory output, a visual output, a haptic output, or any combination thereof. In some embodiments, triggering the alarm may also produce a signal at a central server or central monitoring station that further notifies of a possible theft.

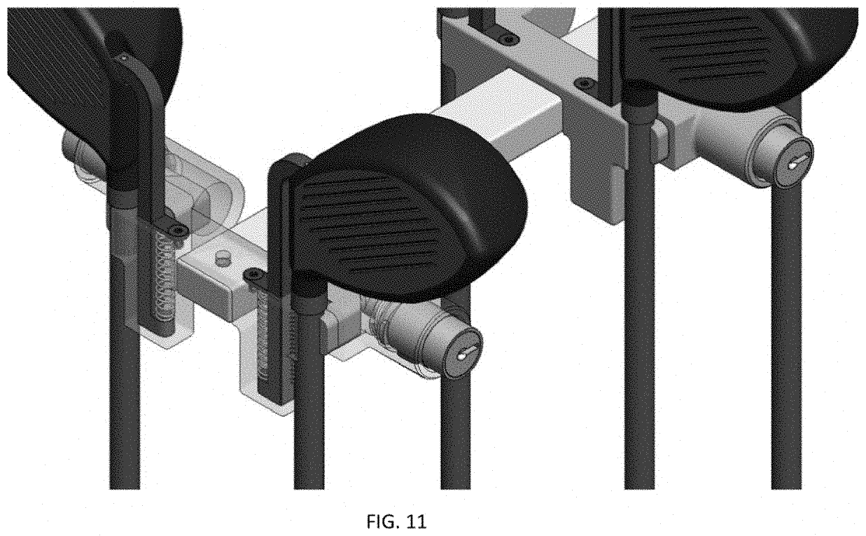

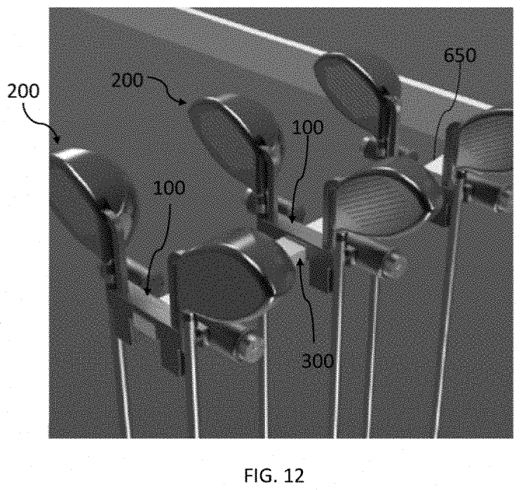

Referring to FIGS. 11 and 12, multiple security apparatuses 100 may be secured to a display fixture 300 in order to secure many golf clubs 200 in a retail setting. In an embodiment, the security apparatus 100 may be configured to secure more than two golf clubs 200 at a time, or may be configured as a smaller unit that only secures a single golf club 200. In a further embodiment, each of the multiple security apparatuses 100 may be in electronic communication with each other and may be capable of being controlled and monitored from a central station as part of a secure display system.

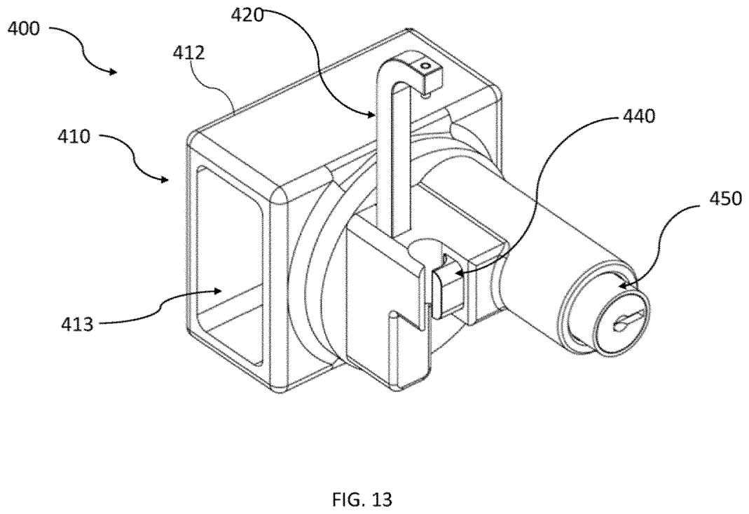

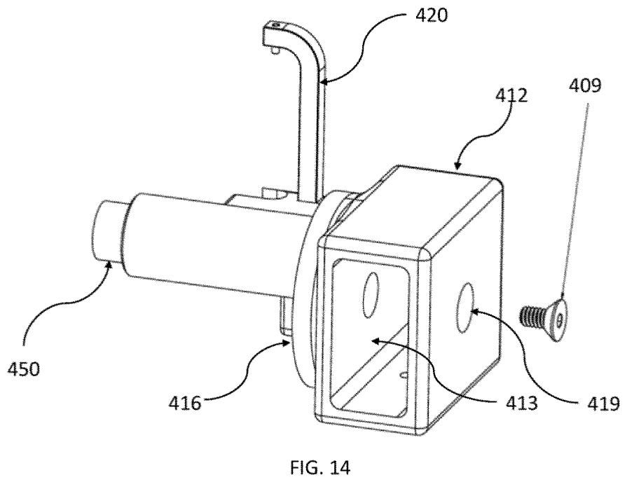

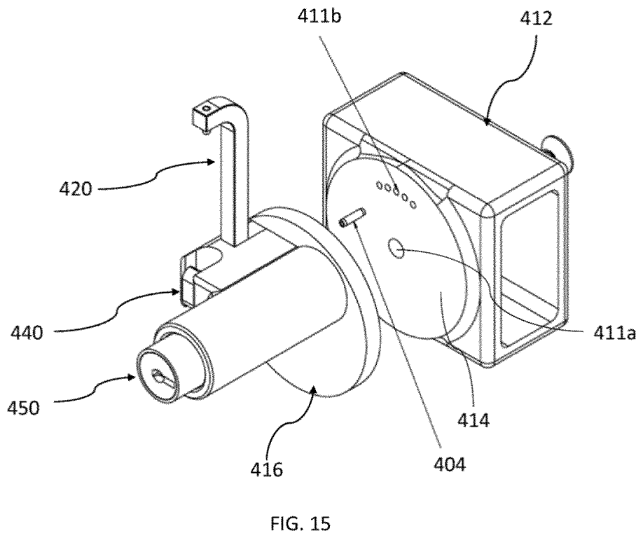

With reference to FIGS. 13-15, another embodiment of the golf club security apparatus 400 is shown that includes a club head securing portion 420, a club shaft securing portion 440, and a locking assembly 450. As can be seen, the housing 410 at least partially surrounds the components of the security apparatus 400. The housing 410 comprises a first housing portion 412 removeably coupled to a second housing portion 416. The first housing portion 412 has a plurality of side surfaces that define a passageway 413 which traverses the first housing portion 412. The first housing portion 412 may further define one or more additional openings 419 that open into the passageway 413 and are configured to accept one or more fasteners 409, such as a threaded safety screw. One side of the first housing portion 412 defines a second housing portion engagement surface or interface 414. As shown, the second housing interface 414 is a raised surface with a circular shape defining an opening or cavity 411a configured to receive part of the second housing portion 416 to enable the second housing portion 416 to pivot or rotate relative to the first housing portion 412. A plurality of recesses 411b are defined on the a second housing portion engagement surface 414 are configured to releasable accept an end of a positioning element 404, such as a positioning pin. The opposing end of the positioning element 404 is releasably coupled to the second housing portion 416.

In an embodiment, the positioning element 404 is spring biased such that when the housing 410 is in the assembled state, the positioning element 404 is configured to move and out of the plurality of recesses 411b as the second housing portion is pivoted relative to the first housing portion 412. When the positioning element 404 is moved into a recess 411b, the rotational position of the second housing portion 416 with regard to the first housing portion 412 is locked. In another embodiment, the second housing portion 416 must be removed from the first housing portion 412 so that the positioning element 404 can be manually positioned within the desired recess 411b. Once positioned, the second housing portion 416 is then recoupled to the first housing portion 412.

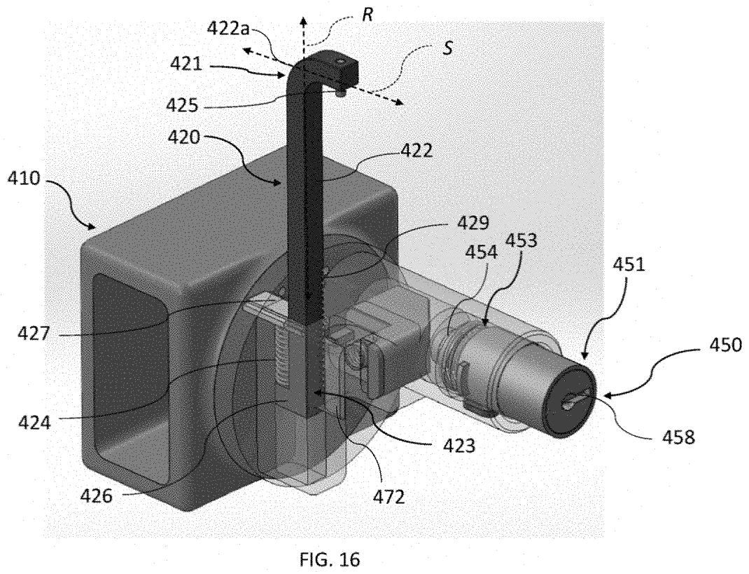

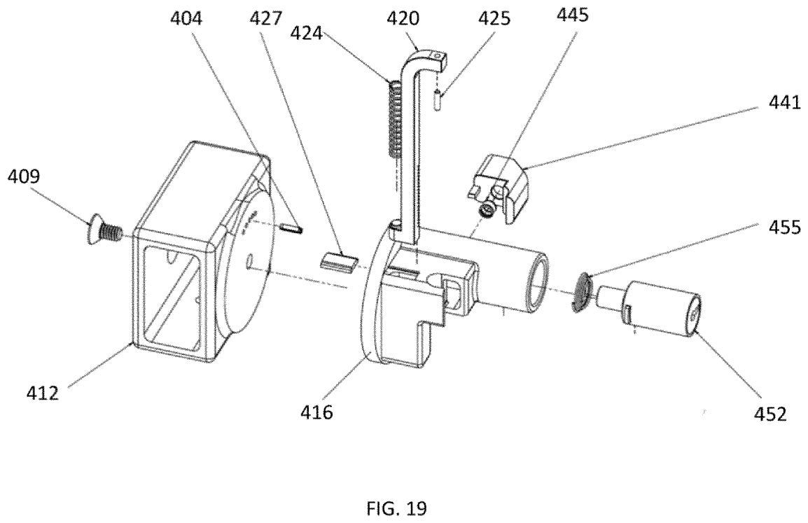

FIGS. 16-18 show images of the security apparatus 400 such that some components located in and normally obscured by the housing 410 may be seen (X-ray view). As shown in the embodiments of FIGS. 16-19, the security apparatus 400 is configured to secure one golf club, however other embodiments of the security apparatus 400 can secure multiple golf clubs. The club head securing portion 420 includes an extension 422 or extension member that extends along an axis R (see FIG. 16) from a first end 421 positioned outside and away from the housing 410 and an second end 423 positioned within the housing 410. The extension member 422 defines a plurality of surface features 429, such as ridges or teeth, on at least one side. The first end 421 includes a transition portion 422a of the extension member 422 that transitions to extend along an axis S that intersects the axis R. An engagement member 425 extends from the first end 421. In an embodiment, the engagement member 425 and the extension member 422 are formed as a single integrated component. In other embodiments, the engagement member 425 is a separate component that is attached to the first end 421 of the extension member 422 and may be replaced with a different engagement member 425 depending on the size and shape of the golf club being secured.

The second end 423 of the extension member 422 is contacts or otherwise accepts a portion of a biasing member 424. In an embodiment, the second end 423 of the extension member 422 includes a shoulder or an extension leg 426, secures or otherwise supports one end of the biasing member 424, such that the second end 423 has an “L-shape” configuration. As shown in FIGS. 16, 17, and 19, the biasing member 424 is a resilient member such as a spring, specifically a coil spring. A plate 427 or covering is coupled to the housing 410 and positioned proximate the extension member 422 and above the extension leg 426. In the embodiments shown in FIGS. 16-18, the resilient member 424 is retained between the extension leg 426 and the plate 427 in order to bias the second end 423 of the extension member 422 away from the plate 427.

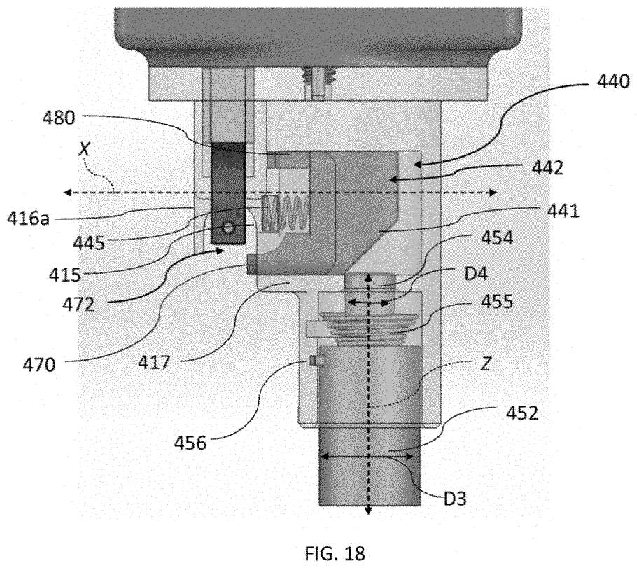

Still referring to FIGS. 16-19, the locking assembly 450 of the security apparatus 400 includes a barrel 452 and a club shaft securing portion 440. The barrel 452 has a first end 451 and an opposing second end 453. In an embodiment, the first end 451 of the barrel 452 defines an opening or lock interface 458 configured to accept a key member (not shown). The second end 453 of the barrel 452 is coupled to or contacts a barrel ram 454. Referring to FIG. 18, the barrel 452 has a first diameter D3 and the barrel ram 454 has a second diameter D4 that is smaller than the first diameter D3. In an embodiment, the barrel 452 and the barrel ram 454 may be formed as a single unitary component. Still referring to FIG. 18, a barrel biasing member 455 is positioned at least partially around the barrel ram 454 and abutting the second end 453 of the barrel 452 of the locking assembly 450. The barrel 452, the barrel ram 454, and the resilient barrel member 455 are at least partially positioned within the second housing portion 416. The second housing portion 416 includes an interior wall 417 or divider defining a passage large enough for the barrel ram 454 to be inserted through, but not large enough for the barrel biasing member 455 or the barrel 452 to pass through. The barrel 452 further includes one or more protruding surfaces 456 that are at least partially accepted by one or more indents, depressions, grooves 418 or other such surface features on the inner surface of the second housing portion 416.

Still referring to FIGS. 16-18, the club shaft securing portion 440 generally includes a body 442 at least partially enclosed within the second housing portion 416. The body 442 contacts one end of a body biasing member 445 and the other end of the body biasing member 445 contacts an inner surface 415 of the second housing portion 416. A first locking extension 470 and a second locking extension 480 extend from the body 442. The body 42 also includes a graduated or angled surface 441 generally at an opposing end of the body 442 from the first and second locking extensions 470, 480.

The barrel biasing member 455 and the body biasing member 445 act to bias the barrel 452 and the body 442 of the club shaft securing portion 440, respectively, into an unlocked state. In order to move the security apparatus 400 from the unlocked state to the locked state, the barrel 452 is depressed into the housing along the barrel axis Z such that the one or more protruding surfaces 456 interact with the one or more indents 418 in the inner surface of the second housing portion 416. Insertion of the barrel 452 advances the barrel ram 454 into the angled surface 441 of the body 442 of the club shaft securing portion 440 while compressing the resilient barrel member 455. As the barrel ram 454 rides along the angled surface 441, the body 442 of the club shaft securing portion 440 is moved along a body axis X and compresses the body biasing member 445. As show in FIG. 18, the barrel axis Z intersects the body axis X. Movement of the body 442 of the club shaft securing portion 440 along the body axis X advances the first and second locking extensions 470, 480. The first locking extension 470 advances outside of the second housing portion 416 and the second locking extension 480 advances toward the extension member 422 and engages the one or more surface features 429 (FIG. 16) of the extension member 422. When the second locking extension 480 engages the one or more surface features 429 (FIG. 16) of the extension member 422, movement of the extension member 422 relative to the second housing portion 416 along the extension member axis R (FIG. 16) is inhibited.

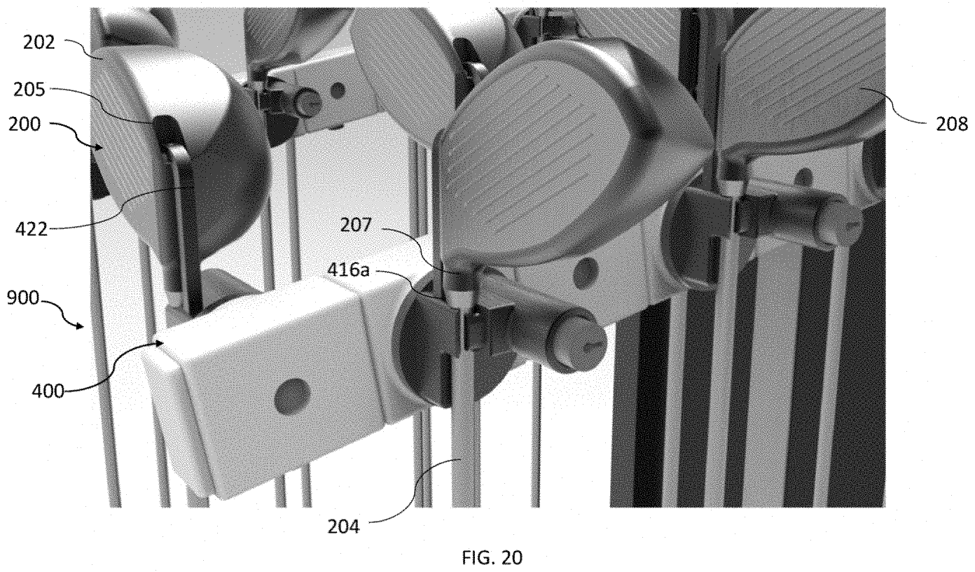

The process of securing and releasing a golf club 200 (see FIGS. 20-22) from the security apparatus 400 will now be described with reference to FIGS. 16-22. One or more aspects of the securing process to be described may be similar to other securing processes that have been previously described. FIG. 16 shows the security apparatus 400 where the barrel 452 of the locking assembly 450 is biased into the unlocked state. When in the unlocked state, the first locking extension 470 is positioned away from the securing wall or shaft pocket 416a of the second housing portion 416 such that a golf club shaft 204 (see FIG. 20) may be inserted into a securing area 472. In the unlocked state, the second locking extension 480 does not engage the extension member 422 of the club head securing portion 420 such the extension member 422 is cable of moving freely along the extension member axis R.

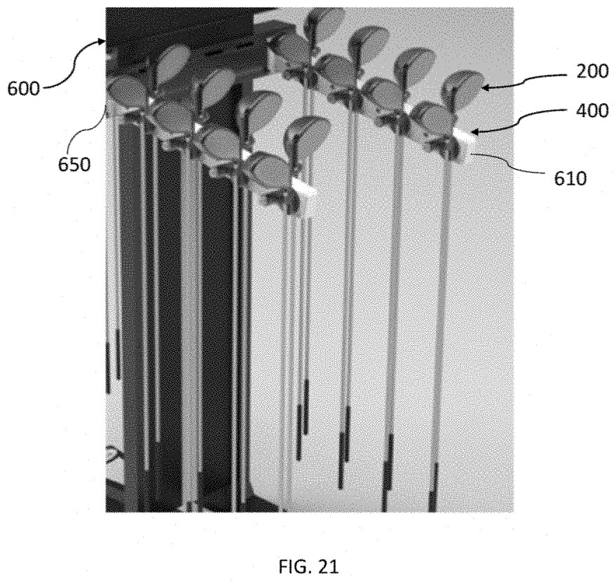

FIGS. 20 and 21 show examples of a secure display system 900 including a plurality of the golf club security apparatuses 400 secured to a display fixture 600. As shown, the secure display system 900 accepts a plurality of golf club 200 that are oriented upside-down so that the club head 202 is above the shaft 204. The type of golf club 200 being secured in the illustrated secure display system 900 is a driver, however it is possible that other types of golf clubs may also be secured using the secure display system 900.

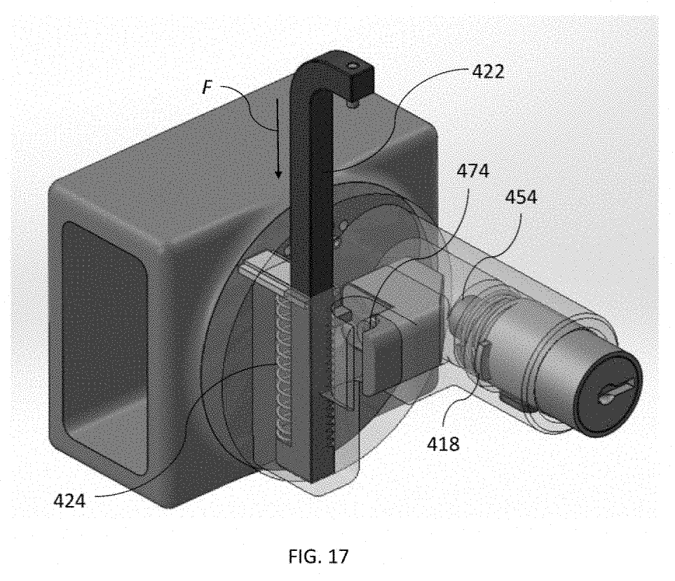

Turning back to FIGS. 16 and 18, when the security apparatus 400 is in the unlocked state as shown, the extension member 422 of the club head securing portion 420 is pulled up along the extension member axis R. The club head 202 of the golf club us then brought into contact with the club head securing portion 420 such that the engagement member 425 is positioned in a club head recess 205, and the extension member 422 is released. A portion of the golf club shaft 204 is then positioned in the securing area 472 defined by the shaft pocket 416a. Referring to FIGS. 20 and 21, the shaft 204 of the golf club 200 is then moved to engage the shaft pocket 416a defined in the second housing portion 416 such that the club head lip 207 may rest on top of the shaft pocket 416a. The resilient member 424 of the club head securing portion 420 acts to exert a force F (see FIG. 17) on the golf club 200 in a direction towards the end of the shaft 204. This force F (see FIG. 17) acts to retain the golf club head 202 between the engagement member 425 and the top of the shaft pocket 416a. At this point, the first locking extension 470 is in a retracted position, which enables the shall 204 to be freely inserted into or removed from the securing area 472 of the shaft pocket 416a.

Turning to FIGS. 18 and 20, once the golf club 200 is positioned within the security apparatus 400, the security apparatus 400 is then moved from the unlocked state to the locked state as will now be discussed. In order to secure the golf club 200 in the security apparatus 400, the barrel 452 is depressed into the second housing portion 416 until the one or more protruding surfaces 456 of the barrel 452 engage the corresponding indent(s) 418 to lock the barrel 452 in place relative to the second housing portion 416. As the barrel 452 is depressed, the barrel biasing member 455 is compressed and the barrel ram 454 rides along the angled surface 441 of the club shaft securing portion 440 to advance the body 442 of the club shaft securing portion 440 along the body axis X. Advancement of the body 442 advances the first locking extension 470 towards the shaft pocket 416a to engage the shaft 204 and/or inhibit the shaft 204 from being freely removed from the shaft pocket 416a. The first locking extension 470 may comprise a shaft engagement surface 474 (see FIG. 17) that is beveled, rounded, or otherwise contoured to the shape of the shaft 204 of the golf club 200. At the same time, the second locking extension 480 moves into engagement with the extension member 422 and engages with at least one of the surface features 429 (FIG. 16) of the extension member 422 to inhibit movement of the extension member 422 along the extension member axis R. The extension member 422 is now inhibited from being lifted away from the club head 202 and the shaft 204 is inhibited from being removed from the shaft pocket 414a. The golf club 200 is now secured within the security apparatus 400.

In order to remove the golf club 200 from the security apparatus 400, the locking assembly 450 is unlocked at the lock interface 458 using a key or other device (not shown) to move the locking assembly 450 from the locked state into the unlocked state. In the unlocked state, the barrel biasing member 455 and the body biasing member 445 are in an uncompressed state and the first and second locking extensions 470, 480 are biased in a retracted position. The golf club shaft 204 is now able to be removed from the securing area 472 of the shaft pocket 416a and the extension member 422 can be lifted away from the golf club head 202.

The key (not shown) to lock and unlock the locking assembly 450 may be any kind of key suitable for locking and unlocking a locking assembly such as a magnetic key, a dimple key, mechanically cut key, or other such key. In a further embodiment, one or more components of the security apparatus 400 may be electronically controlled using one or more actuators and being controlled using a FOB, key card, or a biometric locking system. In an embodiment, the security apparatus 400 comprises an alarm (not shown) configured to be activated if the extension member 422, the lock interface 458, the barrel 452, the first locking extension 470 and/or the second locking extension 480 is damaged. The alarm (not shown) may be powered by a power source located within the housing 410 or may be connected to an external power source. When the alarm (not shown) is triggered, it may produce an auditory output, a visual output, a haptic output, or any combination thereof. In some embodiments, triggering the alarm may also produce a signal at a central server or central monitoring station that further notifies of a possible theft.

Referring to FIGS. 20 and 21, an example of a secure display system 900 is shown with multiple security apparatuses 400 secured to a display fixture 600 in order to secure multiple golf clubs 200 in a retail setting. In an embodiment, the security apparatus 400 may be configured to secure more than two golf clubs 200 at a time, or may be configured as a smaller unit that only secures a single golf club 200. In a further embodiment, each of the multiple security apparatuses 400 may be in electronic communication with each other and may be capable of being controlled and monitored from a central station. In a particular embodiment of the secure display system 900, a plurality of security apparatuses 400 are installed or secured along an extension 610 or support that can be coupled to the display fixture 600. As shown, the extension 610 has a first end 612 that is coupled to the display fixture 600 and has as an adapter 650 that can be replaced according to the type of display fixture 600. In this manner, the extension 610 may be coupled to many different display fixtures 600 by removing and replacing the adapter 650 to accommodate and couple to different display fixtures 600. The extension 610 is inserted into the passageway 413 of the first housing portion 412 of the security apparatus 400. The angle of the second housing portion 416 relative to the first housing portion 412 is then adjusted. Finally, the one or more fasteners 409 are installed to secure the extension 610 within the passageway 413 of the first housing portion 412 to inhibit: (1) removal of the security apparatus 400 from the extension; and (2) rotation of the second housing portion 416 relative to the first housing portion 412.

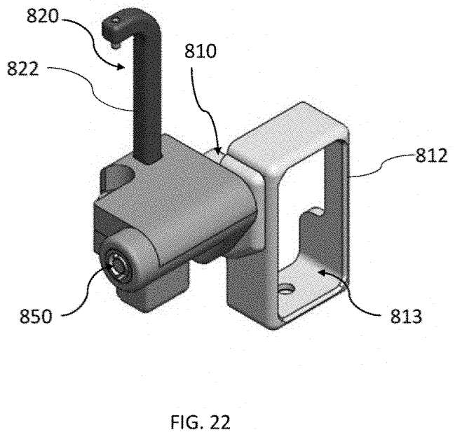

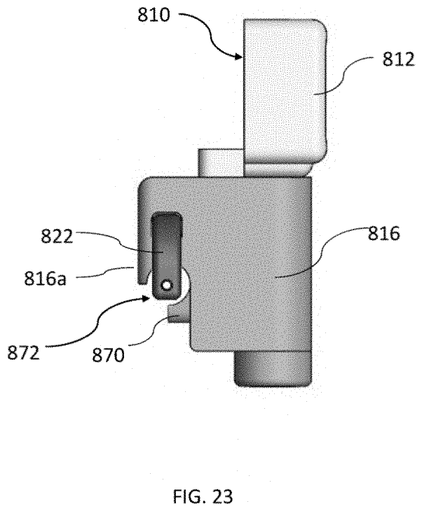

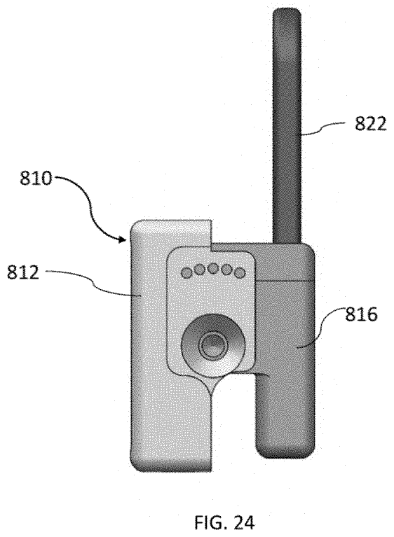

Another embodiment of the security apparatus 800 is shown in FIGS. 22-26. This embodiment of the security apparatus 800 shares many of the same features as other embodiments previously discussed. For example, the security apparatus 800 includes a club head securing portion 820, a club shaft securing portion 840, and a locking assembly 850. A housing 810 at least partially surrounds the components of the security apparatus 800. As shown, the housing 810 includes a first housing portion 812 removeably coupled to a second housing portion 816. The first housing portion 812 has a plurality of side surfaces that define a passageway 813 which traverses the first housing portion 812. The first housing portion 812 may further define one or more additional openings 819 that open into the passageway 813 and are dimensioned to accept one or more fasteners, such as a threaded safety screw. One side of the first housing portion 812 defines a second housing portion engagement surface (not shown). Similar to other embodiments previously discussed, the second housing portion 816 is able to pivot or rotate relative to the first housing portion 812.

Similar to other embodiments of the security apparatus previously discussed, the embodiment of the security apparatus 800 shown in FIGS. 22-26 has a securing head portion 820 that includes an extension member 822 that has a plurality of surface features 829, such as teeth, that acts to secure the golf club head 202. The locking assembly 850 operated in a similar manner as other locking assemblies previously discussed. In other words, the locking assembly 850 acts to extend and retract a first locking extension 870 and a second locking extension (not shown). Accordingly, the golf club shaft 204 is able to be subsequently secured and removed for from the securing area 872 of the shaft pocket 816a, and the extension member 822 can be subsequently secured against the golf club head 202 and lifted away from the golf club head 202.

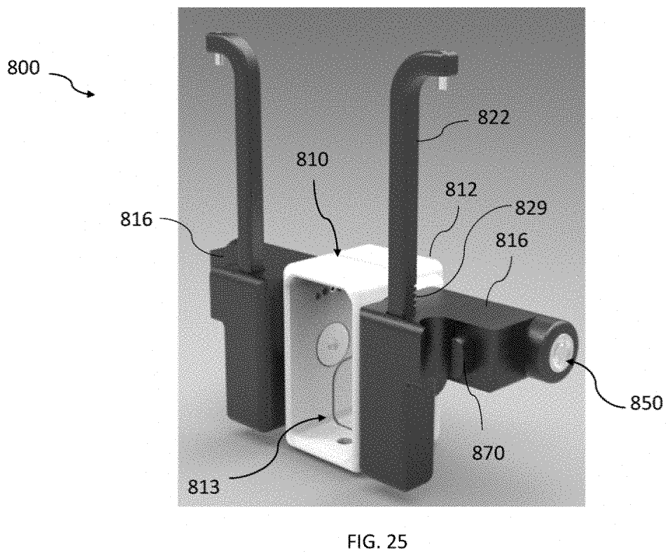

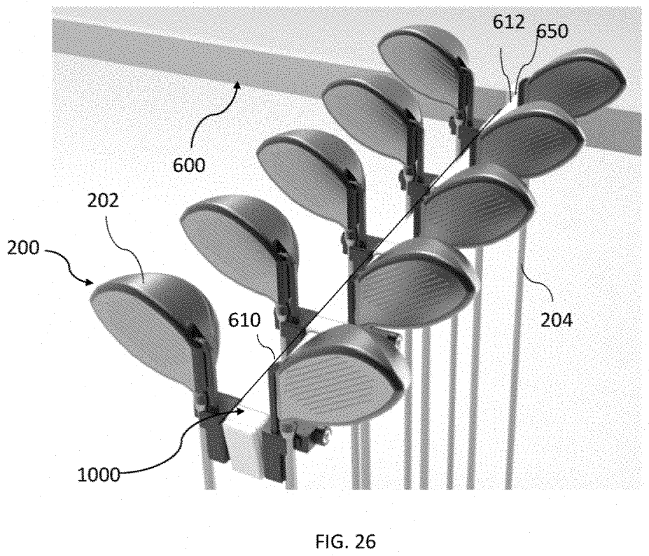

Referring specifically to FIGS. 25 and 26, the security apparatus 800 can be configured to hold more than one golf club 200. As shown, the first housing portion 812 is capable of coupling to two (2) second housing portions 816. In a further embodiment, security apparatus 800 can be in electronic communication with other security apparatuses 800 and is capable of being controlled and monitored from a central station. In another embodiment of a secure display system 1000, a plurality of security apparatuses 800 are capable of being installed or secured along an extension 610 that can be coupled to the display fixture 600 as shown in FIG. 26. The extension 610 has a first end 612 that is coupled to the display fixture 600 and has as an adapter 650 that can be replaced according to the type of display fixture 600. In this manner, the extension 610 may be coupled to many different display fixtures 600 by removing and replacing the adapter 650 to accommodate and couple to different display fixtures 600. The extension 610 is inserted into the passageway 413 of the first housing portion 812 of the security apparatus 800. The angle of the second housing portion 816 relative to the first housing portion 812 is then adjusted. Finally, the one or more fasteners (not shown) are installed to secure the extension 610 within the passageway 813 of the first housing portion 812 to inhibit: (1) removal of the security apparatus 800 from the extension; and (2) rotation of the second housing portion 816 relative to the first housing portion 812.

One advantage that can be realized by the security apparatus 100, 400, 800 is the simple application and removal of a device by sales personnel to prevent theft of golf clubs 200 and club heads 202.

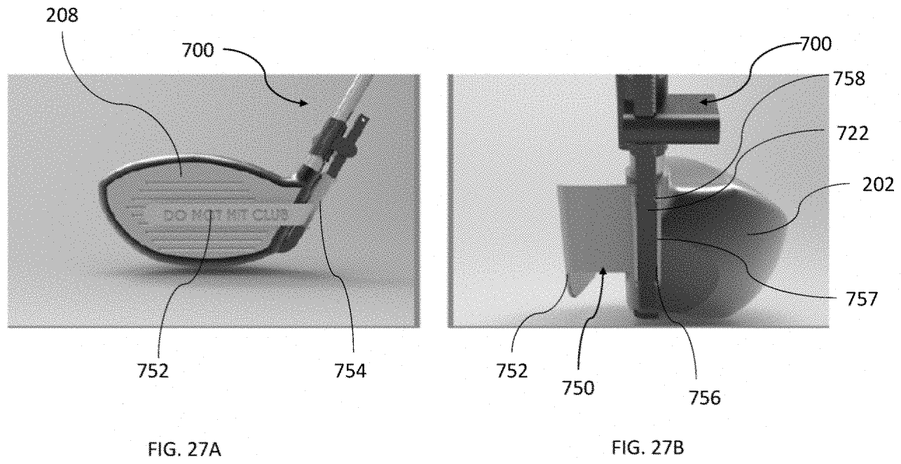

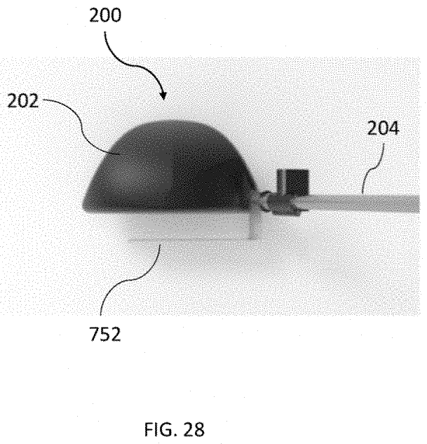

Referring now to FIGS. 27A-B and 28, embodiments of the security apparatuses 100, 400, 800 can include a security apparatus safety device 750 that protects against a consumer trying to hit golf balls or other targets with the golf club 200 while it is retained by the security apparatus 700. The security apparatus safety device 750 will be described with reference to the embodiment of the security apparatus 700 shown, which is not coupled to a display fixture. The security apparatus 700 includes an extension member 722 similar to other embodiments of the security apparatus previously discussed. The security apparatus safety device 750 generally includes one or more club face extensions 752 connected to a coupling portion 754. As shown, the coupling portion 754 includes a channel 756 that accepts a portion of the extension member 722 of the security apparatus 700. In the embodiment shown, the channel 758 has a channel edge 757 that includes one or more projections 758 that partially project into the channel 756. As shown, in FIGS. 27A-B, and 28 the security apparatus safety device 750 is formed as a single component from a plastic or a metal that exhibits some degree of flexibility while maintaining its shape.

In order to install the security apparatus safety device 750 onto the security apparatus 700 that is not securing a golf club 200, a portion of the extension member 722 is inserted into the channel 756 of the coupling portion 754. The flexibility of the coupling portion in addition to the one or more projections 758 enable a snap-fit connection between the security apparatus safety device 750 and the extension member 722. The golf club 200 is then positioned and secured by the security apparatus 700. As shown, the one or more club face extensions 752 extend in front of the club face 208 of the golf club head 202. Accordingly, the one or more club face extensions 752 are positioned such that a consumer would not be able to hot golf balls while the golf club 200 is secured by the security apparatus 700. As shown in FIGS. 27A-B, the position of the golf club 200 when secured by the security apparatus 700 inhibits removal of the security apparatus safety device 750 from the security apparatus 700 when a golf club 200 is secured by the security apparatus 700. In an embodiment, the security apparatus safety device 750 is a different color than the components of the security apparatus 700 or the display fixture 600 in order to make its presence obvious to the consumer. In another embodiment, the one or more club face extensions 752 includes a decal or is embossed with a warning message, such as “Do Not Hit Club” to inform a consumer or retail employee.

The invention is inclusive of combinations of the aspects described herein. References to an “embodiment” and the like refer to features that are present in at least one aspect of the invention. Separate references to “an embodiment” or “particular aspects” or the like do not necessarily refer to the same aspect or aspects; however, such aspects are not mutually exclusive, unless so indicated or as are readily apparent to one of skill in the art. The use of singular or plural in referring to “club” or “clubs” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A security apparatus for securing a golf club, comprising:
a housing defining a pocket;
an extension member including a first end and a second end, wherein the first end extends from the housing and the second end is positioned within the housing;
a lock assembly at least partially positioned within the housing and configured to move between a locked state and an unlocked state, wherein the lock member comprises,
a barrel configured to move relative to the housing, wherein the barrel comprises a lock interface at a first end and a ram operatively coupled to an opposing second end, and
a lock body positioned within the housing and adjacent to the ram;
a first locking extension operatively coupled to the lock body and positioned within the housing; and
a second locking extension at least partially positioned within the housing and operatively coupled to the lock body,
wherein in the locked state,
the first end of the extension member engages a first portion of the golf club,
the first locking extension engages the second end of the extension member to inhibit axial movement of the extension member to secure the lirst portion of the golf club against the extension member, and
the second locking extension extends from the housing to engage a second portion of the golf club,
wherein the golf club is secured between the extension member, the second locking extension and the pocket.

2. The security apparatus of claim 1, wherein the first end of the extension member further comprises an engagement member configured to mate with the first portion of the golf club.

3. The security apparatus of claim 1, wherein the housing comprises a plurality of sides that define a passage configured to accept a portion of a support.

4. The security apparatus of claim 1, wherein the barrel further comprises one or more protruding surfaces configured to engage one or more surface features on an inner surface of the housing when the lock assembly is in the locked state to inhibit axial movement of the barrel relative to the housing.

5. The security apparatus of claim 1, wherein the housing comprises a first housing portion pivotally coupled to a second housing portion, wherein the second housing portion is configured to secure the golf club.

6. The security apparatus of claim 1, wherein in the unlocked state:
the first locking extension is disengaged from the second end of the extension member to enable axial movement of the extension member, and
the second locking extension is retracted from the second portion of the golf club,
wherein the extension member is lifted away from the first portion of the golf club and the second portion of the golf club is enabled to be removed from the pocket of the housing.

7. A security apparatus for securing a piece of sports equipment, comprising:
a housing defining a pocket;
an extension including a first end configured to extend from the housing and a second end positioned within the housing; and
a lock assembly configured to move between a locked state and an unlocked state, wherein the lock assembly comprises,
a barrel configured to move relative to the housing, wherein the barrel comprises a first end and a second end, and
a lock body positioned within the housing and operatively coupled to the barrel;
wherein in a locked state,
the first end of the extension member engages a first portion of the piece of sports equipment,
the lock body engages the second end of the extension member to inhibit axial movement of the extension member to secure the first portion of the piece of sports equipment against the extension member, and
the lock body extends from the housing to engage a second portion of the piece of sports equipment,
wherein the piece of sports equipment is secured between the extension member, the lock body and the pocket.

8. The security apparatus of claim 7, wherein the first end of the extension member further comprises an engagement member configured to mate with the first portion of the piece of sports equipment.

9. The security apparatus of claim 7, wherein the housing comprises a plurality of sides that define a passage configured to accept a portion of a support.

10. The security apparatus of claim 7, wherein the barrel further comprises one or more protruding surfaces configured to engage one or more surface features on an inner surface of the housing when the lock assembly is in the locked state to inhibit axial movement of the barrel relative to the housing.

11. The security apparatus of claim 7, wherein the housing comprises a first housing portion pivotally coupled to a second housing portion, wherein the second housing portion is configured to secure the piece of sports equipment.

12. The security apparatus of claim 7, wherein in the unlocked state:
the body is disengaged from the second end of the extension member to enable axial movement of the extension member; and
the body is retracted from the second portion of the piece of sports equipment,
wherein the extension member is lifted away from the first portion of the piece of sports equipment and the second portion of the piece of sports equipment is enabled to be removed from the pocket of the housing.

13. A secure display system comprising:
a support configured to couple to a display fixture;
a plurality of security apparatuses configured to couple to the support, wherein each of the security apparatuses is configured to secure a piece of sports equipment and comprises,
a housing defining a pocket;
an extension including a first end configured to extend from the housing and a second end positioned within the housing;
a lock assembly configured to move between a locked state and an unlocked state, wherein the lock assembly comprises,
a barrel configured to move relative to the housing, wherein the barrel comprises a first end and a second end, and
a lock body positioned within the housing and operatively coupled to the barrel;
wherein in the locked state,
the first end of the extension member engages a first portion of the piece of sports equipment,
the lock body engages the second end of the extension member to inhibit axial movement of the extension member to secure the first portion of the piece of sports equipment against the extension member, and
the lock body extends from the housing to engage a second portion of the piece of sports equipment,
wherein the piece of sports equipment is secured between the extension member, the lock body and the pocket.

14. The security apparatus of claim 13, wherein the first end of the extension member further comprises an engagement member configured to mate with the first portion of the piece of sports equipment.

15. The security apparatus of claim 13, wherein the housing comprises a plurality of sides that define a passage configured to accept a portion of the support.

16. The security apparatus of claim 13, wherein the barrel further comprises one or more protruding surfaces configured to engage one or more surface features on an inner surface of the housing when the lock assembly is in the locked state to inhibit axial movement of the barrel relative to the housing.

17. The security apparatus of claim 13, wherein the housing comprises a first housing portion pivotally coupled to a second housing portion, wherein the second housing portion is configured to secure the piece of sports equipment.

18. The security apparatus of claim 13, wherein in the unlocked state:
the body is disengaged from the second end of the extension member to enable axial movement of the extension member; and
the body is retracted from the second portion of the piece of sports equipment,
wherein the extension member is lifted away from the first portion of the piece of sports equipment and the second portion of the piece of sports equipment is enabled to be removed from the pocket of the housing.
